(19) United States
(12) Patent Application Publication
(10) Pub. No.: US 2016/0240079 A1
(43) Pub. Date: Aug. 18, 2016

(54) ELECTRONIC PRODUCTION CONTROL METHOD AND ELECTRONIC PRODUCTION CONTROLLER THEREOF

(71) Applicant: TriClouds Corporation, Hsinchu City (TW)

(72) Inventors: CHIEN-HUA SU, Taipei City (TW); YUN-CHENG LIN, Hsinchu City (TW)

(21) Appl. No.: 14/716,330

(22) Filed: May 19, 2015

(30) Foreign Application Priority Data
Feb. 17, 2015 (TW) 104105508

(51) Int. Cl. G08C 17/02

(52) U.S. Cl. CPC G08C 17/02; G08C 2201/92

(57) ABSTRACT

An electronic production control method and electronic production controller thereof are provided. The electronic production controller includes a network transmitting module, a storage module and a processing module. The network transmitting module bases on DLNA standard to receive a reading instruction from a playback platform or to transmit reading data to the playback platform. The storage module includes the reading instruction, a built-in program corresponding to the reading instruction and the reading data. The processing module is electronically coupled to the electronic product and bases on the reading instruction to search the corresponding built-in program in the processing module and the reading data. The processing module uses the built-in program to drive the electronic products and returns the reading data to the playback platform, such that the reading data may be displayed on the playback platform.

### CROSS-REFERENCE TO RELATED APPLICATION

This application claims priority from Taiwan Patent Application No. 104105508, filed on Feb. 17, 2015, in the Taiwan Intellectual Property Office, the content of which are hereby incorporated by reference in their entirety for all purposes.

### BACKGROUND OF THE INVENTION

1. Field of the Invention

The following description relates to an electronic production control method, particularly to carry out the electronic production control method by using an electronic production controller.

2. Description of the Related Art

The more diverse the technology of digital audio-visual to be shared, the more serious the problem of compatibility is. In order to mitigate such problem, making users to enjoy audio-visual experience with relaxation, it is necessary to integrate completely and seamlessly between apparatus. Digital Living Network Alliance, DLNA was developed based on the concept of the digital family. The purpose of the alliance is to establish a unified transmission standard, so that different brands and types of audio-visual machines may communicate with each other, to prevent different electronic products from requiring different remote controls.

The audio-visual machines designed according to the DLNA criteria, its terminal product may transmit the high-quality multimedia streaming content to each other through wireless or wired connection. Apart from the network support being an essential condition, DLNA also employs the technology of UPnP (Universal Plug and Play) to achieve seamless connection for home digital products.

However, there are still many defects in the current technology of DLNA, for example, its function does not have flexibility. The current technology of DLNA only can read relevant audio-visual files or photos from another electronic product, such as computer, media player and display on a playback platform, but cannot carry out control functions such as modification through different instructions. Also, how to control other electronic products in the current DLNA standard through a seamless integration and low cost way becomes a problem required to be solved as soon as possible.

### SUMMARY OF THE INVENTION

In view of the conventional problems described above, the purpose of the present invention is to provide an electronic production control method, so that apart from the reading function, the original control method through the DLNA standard will be more flexible in the operation.

In view of the conventional problems described above, the purpose of the present invention is to provide an electronic production control method, so that other electronic products may be controlled by using low cost way on the existing DLNA.

In view of the conventional problems described above, the purpose of the present invention is to provide an electronic production control method, so that other electronic products may be controlled by using an integrated manner on the existing DLNA.

According to the aforementioned purpose, the present invention provides an electronic production control method applicable to an electronic production controller and a playback platform transmitting data to each other in a same network domain according to DLNA standard (Digital Living Network Alliance Standard). The control method includes the following steps: coupling an electronic product to the electronic production controller electrically; inputting a reading instruction to the electronic product via the playback platform; transmitting the reading instruction from the playback platform to the electronic production controller according to the DLNA standard; searching reading data and a corresponding built-in program corresponding to the reading instruction in the electronic production controller; executing the built-in program by the electronic production controller to drive the electronic product; and returning the reading data to the playback platform and display the reading data on the playback platform.

Preferably, the playback platform includes a television, a set top box or a blue-ray disc player which support the DLNA standard.

Preferably, the electronic production controller further includes a socket. The electronic product is installed in the socket, such that the electronic production controller controls switch-on/switch-off of the electronic product.

Preferably, the electronic production controller further includes a wireless remote control module corresponding to the electronic product. The electronic production controller executes the built-in program to drive the wireless remote control module transmitting a control instruction to the electronic product wirelessly. The electronic product carries out corresponding operations after receiving the control instruction.

Preferably, the reading instruction, the reading data and the built-in program are stored in a lookup table of the electronic production controller.

According to the aforementioned purpose, the present invention also provides an electronic production controller applicable to support a playback platform of DLNA standard (Digital Living Network Alliance Standard) in a same network domain. The electronic production controller includes a network transmission module, a storage module and a processing module. The network transmission module may receive a reading instruction from the playback platform, or transmit a reading data to the playback platform according to the DLNA standard. The storage module may include the reading instruction, a built-in program corresponding to the reading instruction and the reading data. The processing module may electrically couple to an electronic product. The processing module searches the corresponding built-in program in the storage module and the reading data according to the reading instruction. The processing module uses the built-in program to drive the electronic product and return the reading data to the playback platform, such that the reading data is displayed on the playback platform.

Preferably, the playback platform includes a television, a set top box or a blue-ray disc player which support the DLNA standard.

Preferably, the electronic production controller further includes a socket. The electronic product is installed in the socket. The electronic production controller may control switch-on/switch-off of the electronic product via the socket.

Preferably, the electronic production controller further includes a wireless remote control module corresponding to the electronic product. The electronic production controller executes the built-in program to drive the wireless remote control module transmitting a control instruction to the electronic product wirelessly. The electronic product carries out corresponding operations after receiving the control instruction.

Preferably, the reading instruction, the reading data and the built-in program are stored in a lookup table.

### BRIEF DESCRIPTION OF THE DRAWINGS

The above and other features and advantages of the present invention will become more apparent by illustrating the exemplary embodiments thereof in detail with reference to the accompanying drawings, wherein:

FIG. 1 is a block diagram according to the electronic production controller of the present invention.

FIG. 2A is the first schematic diagram of the electronic production controller according to another embodiment of the present invention.

FIG. 2B is the second schematic diagram of the electronic production controller according to another embodiment of the present invention.

FIG. 2C is the third schematic diagram of the electronic production controller according to another embodiment of the present invention.

FIG. 3 is a step flowchart according to the control method of the present invention.

### DETAILED DESCRIPTION OF THE PREFERRED EMBODIMENTS

In order to facilitate the understanding of the features, the contents and the advantages of the present invention, and the effectiveness thereof that can be achieved, the present invention will be illustrated in detail below through embodiments with reference to the accompanying drawings. On the other hand, the diagrams used herein are merely intended to be schematic and auxiliary to the specification, but are not necessary to be true scale and precise configuration after implementing the present invention. Thus, it should not be interpreted in accordance with the scale and the configuration of the accompanying drawings to limit the scope of the present invention on the practical implementation.

The advantages, the features and the achieved technical method of the present invention will be more readily understood by illustrating in greater detail with reference to the exemplary embodiments and the accompanying drawings. The present invention may be embodied in different forms, and thus should not be construed as only limited to the embodiments stated herein. On the contrary, to the person having ordinary skilled in the concerned art, the embodiments provided would make this disclosure more thorough and complete and fully convey the scope of the present invention, and the present invention will only be defined by the appended claims.

In accordance with the embodiment(s) of the present invention, the components, process steps, and/or data structures described herein may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card and paper tape, and the like) and other known types of program memory.

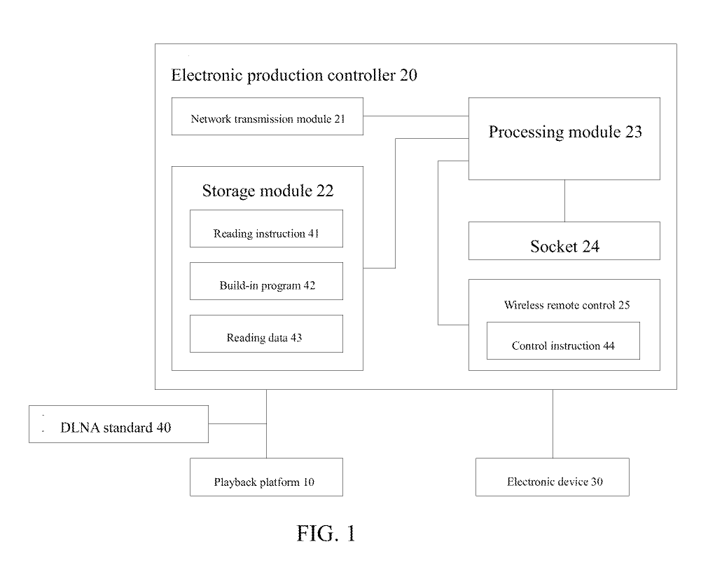

Please refer to FIG. 1, which is the block diagram according to the electronic production controller of the present invention. The electronic production controller is applicable to a playback platform 10 having DLNA standard (Digital Living Network Alliance Standard) 40 in a same network domain. The electronic production controller 20 includes a network transmission module 21, a storage module 22 and a processing module 23. The playback platform 10 may be a television, a multimedia player, a set-top box or a blue-ray disc player which support DLNA functions, and the playback platform 10 is required to support wired/wireless network transmission. The electronic production controller 20 may be a small embedded type system. The processing module 23 may include a microcontroller or a central processor. The storage module 22 may be a random access memory. The network transmission module 21 may be a network transmission chip to receive or transmit data.

In detail, the network transmission module 21 may receive a reading instruction 41 from the playback platform 10 according to the DLNA standard 40. The reading instruction 41 may be inputted in an interface menu of the playback platform 10 by the users, and the reading instruction 41 is used to operate an electronic product 30. On the other hand, the network transmission module 21 may also be used to transmit a reading data 43 to the playback platform 10.

The storage module 22 may include the reading instruction 41, the built-in program 42 corresponding to the reading instruction 41 and the reading data 43. The reading instruction 41, the reading data 43 and the built-in program 42 may be stored in a lookup table. Processing module 23 is electrically coupled to the electronic product 30. And when the processing module 23 receives the reading instruction 41, the processing module 23 will search the corresponding built-in program 42 in the storage module 22 and the reading data 43 immediately. The processing module 23 then uses the built-in program 42 to drive electronic product 30 and return the reading data 43 to the playback platform 10, such that the reading data 43 is displayed on the playback platform 10.

For further explanation, electronic production controller 20 may further include a socket 24 or a wireless remote control module 25. The electronic product 30 may be installed in the socket 24, and the electronic production controller 20 may use the socket 24 to control switch-on/switch-off of the electronic product 30. On the other hand, wireless remote control module 25 may also be used to control the electronic product 30. The electronic production controller executes the built-in program 42 to drive the wireless remote control module 25 transmitting a control instruction 44 to the electronic product 30 by way of wireless transmission, such that the electronic product 30 carries out corresponding operations after receiving the control instruction 44.

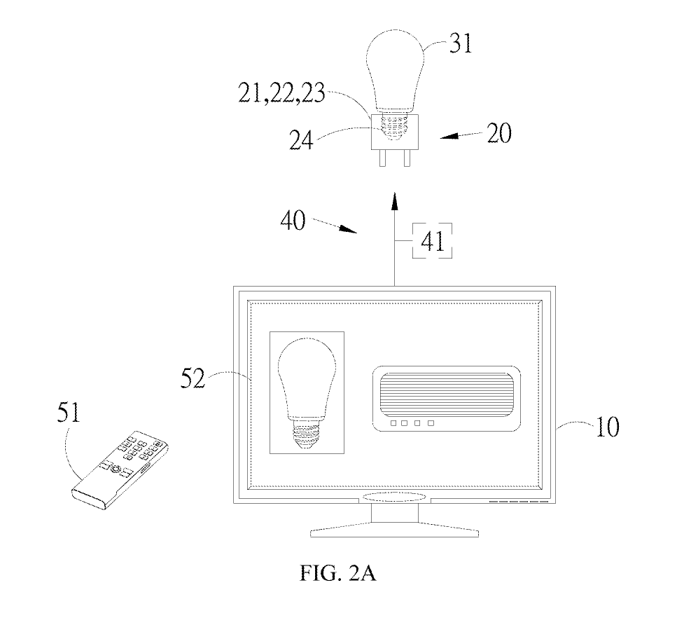

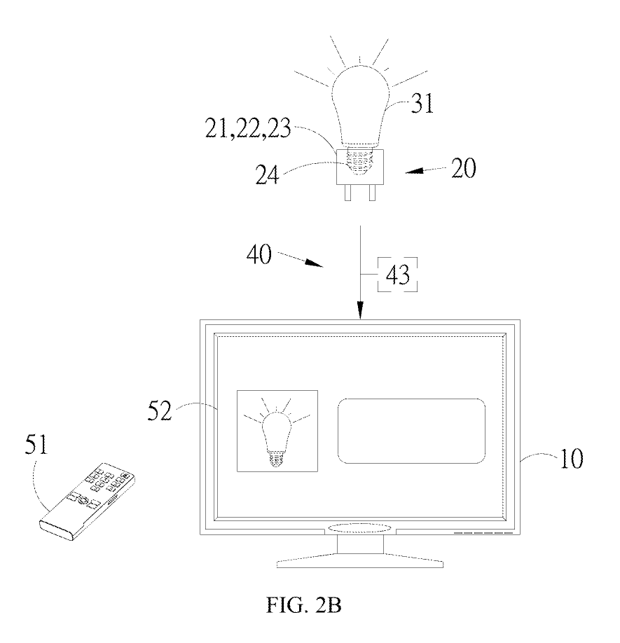

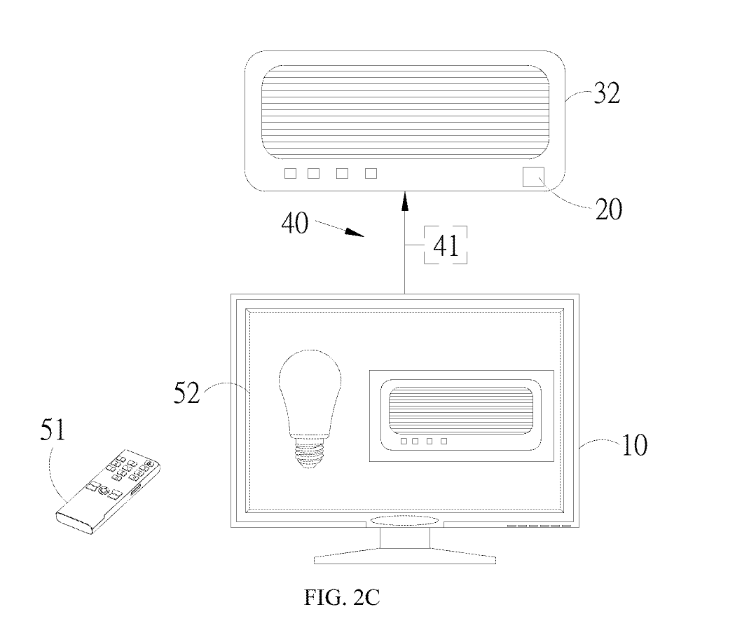

Please also refer to FIG. 2A, FIG. 2B and FIG. 2C, which are the first schematic diagram, the second schematic diagram and the third schematic diagram of the electronic production controller according to another embodiment of the present invention. The electronic product 30 of this embodiment takes a light bulb 31 as an example for implementation, the playback platform 10 takes a television which supports DLNA function as an example for implementation, but it is not limited thereto, the playback platform 10 may connect to the electronic production controller 20 through a wired network or a wireless network. In this embodiment, the electronic production controller 20 is an embedded type device which is electrically coupled to the light bulb 31. The embedded type device may have a socket 24 which includes the light bulb 31, such that the light bulb 31 may be placed in the embedded type device.

When the users intend to control the light bulb 31 through the present invention, it is only required to hold a remote control 51 and select a device which is available to use the DLNA standard 40 for communication in the current environment on a switch-on power playback platform 10. As shown in FIG. 2A, the screen 52 shows an icon of the corresponding light bulb 31 immediately at this moment. When the users intend to switch on the power of the light bulb 31, it is only required to press the “Enter” or “Select” button of the icon to transmit a signal. And after the playback platform 10 receives the signal of the remote control 51, a reading instruction 41 to the light bulb 31 is transmitted to the electronic production controller 20 through the DLNA standard 40 immediately. The reading instruction 41 is transmitted by the network transmission module 21 at this moment, and the processing module 23 searches the corresponding built-in program (not shown in the figure) in the storage module 22 and the reading data 43 according to the reading instruction 41. The light bulb 31 is then driven by the built-in program drive and thus switches on the power at this moment, whereas the reading data 43 is returned to the playback platform 10 through the DLNA standard 40 players and is displayed on the screen 52, wherein the reading data 43 may a text or an image to show the operation of controlling the light bulb 31 as a successful operation.

As shown in FIG. 2C, the electronic production controller 20 may also be installed on the air conditioner 32 which may receive the driving instructions of the electronic production controller 20. The electronic production controller 20 may be installed and connected to the circuit board of the air conditioner 32 during the manufacturing of the air conditioner 32, or connected to the air conditioner 32 through a regulated standard connection, whereas the way by which the users use the remote control 51 to operate the air conditioner 32 is similar to the descriptions of FIG. 2A and FIG. 2B, and thus it is not repeated herein.

It should be noticed that it is necessary for the electronic production controller 20 to be directed to different types of electronic products 30 to provide different driving designs. The reason is that different types of electronic products 30 has its different ways and interfaces for receiving the driving instructions. Therefore, for the implementation, it is also necessary for the electronic production controller 20 to have a corresponding design directing to different interfaces and different ways of driving instructions.

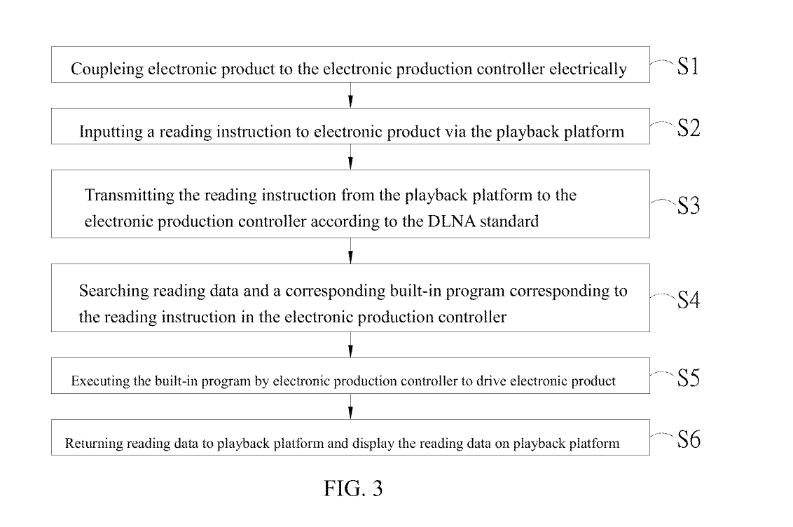

Please refer to FIG. 3, which is a step flowchart according to the control method of the present invention. The control method is applicable to an electronic production controller and a playback platform transmitting data to each other in a same network domain according to DLNA standard (Digital Living Network Alliance Standard). The control method includes the following steps.

Step S1 coupling an electronic product to the electronic production controller electrically.

Step S2 inputting a reading instruction to the electronic product via the playback platform.

Step S3 transmitting the reading instruction from the playback platform to the electronic production controller according to the DLNA standard.

Step S4 searching reading data and a corresponding built-in program corresponding to the reading instruction in the electronic production controller.

Step S5 executing the built-in program by the electronic production controller to drive the electronic product.

Step S6 returning the reading data to the playback platform and display the reading data on the playback platform.

The details of the above steps S1-S6 have been described in the contents of implementation of FIG. 2A and FIG. 2B, and thus it is not repeated herein.

To conclude above as one can know, the control method and the electronic production controller provided by the present invention enable the control method through the DLNA standard to be more flexible. And the users may control other electronic products on the existing DLNA standard by a low-cost and integrated manner. This makes users living in a real intelligent environment.

The embodiments described are merely to illustrate the technical thinking and features of the present invention, the purpose thereof is to enable those skilled in the art can understand the contents of the present invention and implement accordingly. Thus, the scope of claims of the present invention should not be limited by this, that is, the equivalent changes or modifications made in accordance with all spirits disclosed by the present invention should still be encompassed within the scope of claims of the present invention.

What is claimed is:

1. An electronic production control method applicable to an electronic production controller and a playback platform transmitting data to each other in a same network domain according to DLNA standard (Digital Living Network Alliance Standard), the control method comprises:
coupling an electronic product to the electronic production controller electrically;
inputting a reading instruction to the electronic product via the playback platform;
transmitting the reading instruction from the playback platform to the electronic production controller according to the DLNA standard;
searching reading data and a corresponding built-in program corresponding to the reading instruction in the electronic production controller;
executing the built-in program by the electronic production controller to drive the electronic product; and
returning the reading data to the playback platform and display the reading data on the playback platform.

2. The control method of claim 1, wherein the playback platform comprises a television, a set top box or a blue-ray disc player which support the DLNA standard.

3. The control method of claim 1, wherein the electronic production controller further comprises a socket, the electronic product is installed in the socket, such that the electronic production controller controls switch-on/switch-off of the electronic product.

4. The control method of claim 1, wherein the electronic production controller further comprises a wireless remote control module corresponding to the electronic product, the electronic production controller executes the built-in program to drive the wireless remote control module transmitting a control instruction to the electronic product wirelessly, the electronic product carries out corresponding operations after receiving the control instruction.

5. The control method of claim 1, wherein the reading instruction, the reading data and the built-in program are stored in a lookup table of the electronic production controller.

6. An electronic production controller applicable to support a playback platform of DLNA standard (Digital Living Network Alliance Standard) in a same network domain, the electronic production controller comprising:
a network transmission module receiving a reading instruction from the playback platform, or transmitting a reading data to the playback platform according to the DLNA standard;
a storage module comprising the reading instruction, a built-in program corresponding to the reading instruction and the reading data;
a processing module electrically coupling to an electronic product, the processing module searches the corresponding built-in program in the storage module and the reading data according to the reading instruction, the processing module uses the built-in program to drive the electronic product and return the reading data to the playback platform, such that the reading data is displayed on the playback platform.

7. The electronic production controller of claim 6, wherein the playback platform comprises a television, a set top box or a blue-ray disc player which support the DLNA standard.

8. The electronic production controller of claim 6, wherein the electronic production controller further comprises a socket, the electronic product is installed in the socket, the electronic production controller controls switch-on/switch-off of the electronic product via the socket.

9. The electronic production controller of claim 6, wherein the electronic production controller further comprises a wireless remote control module corresponding to the electronic product, the electronic production controller executes the built-in program to drive the wireless remote control module transmitting a control instruction to the electronic product wirelessly, the electronic product carries out corresponding operations after receiving the control instruction.

10. The electronic production controller of claim 6, wherein the reading instruction, the reading data and the built-in program are stored in a lookup table.
